(19) United States
(12) Patent Application Publication
(10) Pub. No.: US 2019/0287179 A1
(43) Pub. Date: Sep. 19, 2019

(54) SHAREHOLDER BENEFIT SYSTEM, SHAREHOLDER BENEFIT METHOD AND PROGRAM

(71) Applicant: OPTiM Corporation, Saga-shi (JP)

(72) Inventor: Shunji SUGAYA, Tokyo (JP)

(21) Appl. No.: 16/302,119

(22) PCT Filed: May 17, 2016
(86) PCT No.: PCT/JP2016/064663

§ 371 Date: Nov. 16, 2018

(51) Int. Cl. G06Q 40/06; G06Q 40/04

(52) U.S. Cl. CPC G06Q 40/06; G06Q 40/04

(57) ABSTRACT

It is an object to provide a shareholder benefit system, a shareholder benefit method, and a program, for improving the convenience of a shareholder. A shareholder bonus system 1 for giving a benefit to a shareholders on a daily or timely basis detects a shareholder ID holding a stock at an end of stock trading or at predetermined time intervals, determines a stock item held by the detected shareholder ID, and gives a benefit to the shareholder ID on a daily or timely basis based on the determined stock item.

### TECHNICAL FIELD

The present invention relates to a shareholder benefit system, a shareholder benefit method, and a program for giving a benefit to a shareholder.

### BACKGROUND ART

Conventionally, a company that issues shares generally gives shareholder benefits to shareholders who holds this shares. As such shareholder benefits, for example, there are money distribution, and gift certificates which can be used for products being sold or services being provided by this company.

As a configuration of shareholder benefits, a configuration in which a point according to the number of shares is given to a shareholder and the shareholder consume this point and receive the desired goods and services is disclosed (see Patent Document 1)

### PRIOR ART DOCUMENT

### Patent Document

Patent Document 1: Japanese Patent Application Publication No. 2007-323539

### SUMMARY OF THE INVENTION

### Technical Problem

However, in the configuration of Patent Document 1, since the timing at which the point is given is usually a settlement date of the company issuing the shares, it is difficult to give the shareholder benefit to the shareholder who has released the shares before the settlement date Therefore, the convenience is low for the shareholders.

An object of the present invention is to provide a shareholder benefit system, a shareholder benefit method and a program for improving the convenience of shareholders.

### Technical Solution

The present invention provides the following solutions.

An invention according to a first aspect provides a shareholder benefit system for giving a benefit to a shareholder on a daily basis, the shareholder benefit system including a shareholder detecting unit that detects a shareholder ID holding a stock at an end of stock trading, a stock item determining unit that determines a stock item held by the detected shareholder ID, and a shareholder benefit unit that gives a benefit to the shareholder ID on a daily basis based on the determined stock item.

According to the first aspect of the invention, a shareholder benefit system for giving a benefit to a shareholder on a daily basis detects a shareholder ID holding a stock at an end of stock trading, determines a stock item held by the detected shareholder ID, and gives a benefit to the shareholder ID on a daily basis based on the determined stock item.

The invention according to the first aspect is a category of the shareholder benefit system, but even in other categories such as a method or a program, exhibits the same action and effect corresponding to the category.

An invention according to a second aspect provides a shareholder benefit system which is the invention according to the first aspect, wherein the shareholder benefit unit that gives a login right to a dedicated service associated with the shareholder ID on the daily basis based on the determined stock item.

According to the second aspect of the invention, a shareholder benefit system, which is the invention according to the first aspect, gives a login right to a dedicated service associated with the shareholder ID on the daily basis based on the determined stock item.

An invention according to a third aspect provides a shareholder benefit system which is the invention according to the first aspect, wherein the shareholder benefit unit that associates a point with the shareholder ID on the daily basis based on the determined stock item.

According to the third aspect of the invention, a shareholder benefit system, which is the invention according to the first aspect, associates a point with the shareholder ID on the daily basis based on the determined stock item.

An invention according to a fourth aspect provides a shareholder benefit system, which is the invention according to the third aspect, further including a rank changing and managing unit that changes and manages a rank of a shareholder associated with the shareholder ID when the associated point satisfies a predetermined condition.

According to the fourth aspect of the invention, a shareholder benefit system, which is the invention according to the third aspect, changes and manages a rank of a shareholder associated with the shareholder ID when the associated point satisfies a predetermined condition.

An invention according to a fifth aspect provides a shareholder benefit system for giving a benefit to a shareholder on a timely basis, the shareholder benefit system including a shareholder detecting unit that detects a shareholder ID holding a stock at predetermined time intervals, a stock item determining unit that determines a stock item held by the detected shareholder ID, and a shareholder benefit unit that gives a benefit to the shareholder ID on a timely basis based on the determined stock item.

According to the fifth aspect of the invention, a shareholder benefit system for giving a benefit to a shareholder on a timely basis detects a shareholder ID holding a stock at predetermined time intervals, determines a stock item held by the detected shareholder ID, and gives a benefit to the shareholder ID on a timely basis based on the determined stock item.

The invention according to the fifth aspect is a category of the shareholder benefit system, but even in other categories such as a method or a program, exhibits the same action and effect corresponding to the category.

An invention according to a sixth aspect provides a shareholder benefit system which is the invention according to the fifth aspect, wherein the shareholder benefit unit that gives a login right to a dedicated service associated with the shareholder ID on the timely basis based on the determined stock item.

According to the sixth aspect of the invention, a shareholder benefit system, which is the invention according to the fifth aspect, gives a login right to a dedicated service associated with the shareholder ID on the timely basis based on the determined stock item.

An invention according to a seventh aspect provides a shareholder benefit system which is the invention according to the fifth aspect, wherein the shareholder benefit unit that associates a point with the shareholder ID on the timely basis based on the determined stock item.

According to the seventh aspect of the invention, a shareholder benefit system, which is the invention according to the fifth aspect, associates a point with the shareholder ID on the timely basis based on the determined stock item.

An invention according to an eight aspect provides a shareholder benefit system, which is the invention according to the seventh aspect, further including a rank changing and managing unit that changes and manages a rank of a shareholder associated with the shareholder ID when the associated point satisfies a predetermined condition.

According to the eighth aspect of the invention, a shareholder benefit system, which is the invention according to the seventh aspect, changes and manages a rank of a shareholder associated with the shareholder ID when the associated point satisfies a predetermined condition.

An invention according to a ninth aspect provides a shareholder benefit method for giving a benefit to a shareholder on a daily basis, the shareholder benefit method including detecting a shareholder ID holding a stock at an end of stock trading, determining a stock item held by the detected shareholder ID, and giving a benefit to the shareholder ID on a daily basis based on the determined stock item.

An invention according to a tenth aspect provides a shareholder benefit method for giving a benefit to a shareholder on a timely basis, the shareholder benefit method including detecting a shareholder ID holding a stock at predetermined time intervals, determining a stock item held by the detected shareholder ID, and giving a benefit to the shareholder ID on a timely basis based on the determined stock item.

An invention according to an eleventh aspect provides a program for causing a shareholder benefit system for giving a benefit to a shareholder on a daily basis to execute detecting a shareholder ID holding a stock at an end of stock trading, determining a stock item held by the detected shareholder ID, and giving a benefit to the shareholder ID on a daily basis based on the determined stock item.

An invention according to a twelfth aspect provides a program for causing a shareholder benefit system for giving a benefit to a shareholder on a timely basis to execute detecting a shareholder ID holding a stock at predetermined time intervals, determining a stock item held by the detected shareholder ID, and giving a benefit to the shareholder ID on a timely basis based on the determined stock item.

### Effects of the Invention

According to the present invention, it is possible to provide a shareholder benefit system, a shareholder benefit method, and a program for improving the convenience of shareholders.

### BRIEF DESCRIPTION OF THE DRAWINGS

FIG. 1 is a diagram showing an overview of a shareholder benefit system 1.

FIG. 2 is an overall configuration diagram of a shareholder benefit system 1.

FIG. 3 is a functional block diagram of a server 10 and a shareholder terminal 100.

FIG. 4 is a diagram showing a shareholder benefit process executed by a server 10 and a shareholder terminal 100.

FIG. 5 is a stock item database.

FIG. 6 is a shareholder database.

FIG. 7 is a rank database.

FIG. 8 is a benefit database.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

Overview of Shareholder Benefit System 1

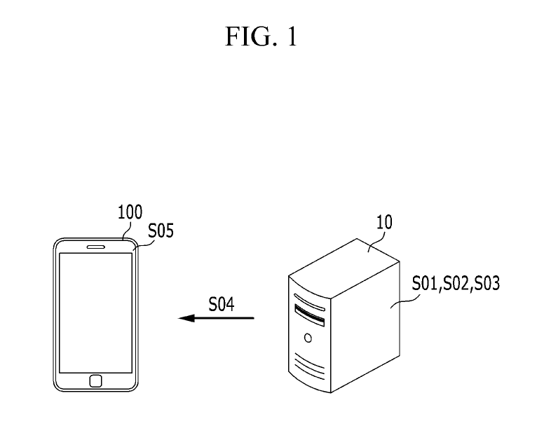

An overview of a preferred embodiment of the present invention is described with reference to FIG. 1. FIG. 1 is a diagram for explaining an overview of a shareholder benefit system 1 which is a preferred embodiment of the present invention. The shareholder benefit system 1 includes a server 10 and a shareholder terminal 100.

In FIG. 1, the number of shareholder terminal(s) 100 is not limited to one, but may be two or more. Further, the server 10 or the shareholder terminal 100 may be a virtual device as well as an existing device. Furthermore, each process to be described below may be realized by either of the server 10 or the shareholder terminal 100, or both of them.

The server 10 is a server device capable of performing data communication with the shareholder terminal 100.

The shareholder terminal 100 is a terminal device possessed by a shareholder and capable of performing data communication with the server 10. The shareholder terminal 100 is, for example, a mobile phone, a portable information terminal, a tablet terminal, a personal computer, an electric appliance such as a netbook terminal, a slate terminal, an electronic book terminal, or a portable music player, a wearable terminal such as a smart glasses or a head mount display, or other goods.

The server 10 detects a shareholder ID holding a stock at an end of stock trading or at predetermined time intervals (step S01). The end time of the stock trading is, for example, an end time of a morning session or afternoon session, an end time of all morning and afternoon sessions, an end time of transaction of securities, or the like. Further, the predetermined time intervals are, for example, every 30 minutes, hourly, every 2 hours, every 2 hours and 30 minutes, every 12 hours, every 24 hours, or the like. The shareholder ID is an ID for identifying a shareholder to be assigned to one shareholder. This ID may be assigned when the shareholder opens an account, may be assigned to the shareholder who uses this system, or may be assigned by other configuration. The server 10 detects the shareholder IDs that are holders in preset stocks or all stocks, from a server of a securities company, the shareholder terminal 100, the other server, a database, or the like.

The server 10 determines a stock item held by the shareholder associated with the detected shareholder ID (step S02). The server 10 determines the stock item by acquiring a stock item of the stock held by the detected shareholder ID.

The server 10 extracts a shareholder benefit associated with the acquired stock item of each stock and grants the shareholder benefit to the shareholder ID on a daily or timely basis (step S03). The shareholder benefit may be, for example, a right to log in to a dedicated service associated with the shareholder ID, a right to install a dedicated application associated with the shareholder ID, or a service right capable of receiving a product or service of a company issuing the stock, such as a coupon or gift certificate.

Further, the server 10 may be configured to give a point based on the number of shares held by the shareholder, the number of holding days or holding time, and the like. When this point satisfies a predetermined condition, a rank of the shareholder associated with the shareholder ID may be changed and managed. Regarding the predetermined condition, for example, the rank of the shareholder is increased when the point exceeds a predetermined value, or conversely, the rank of the shareholder is decreased when the point falls below the predetermined value. The server 10 may change the content of the above-mentioned shareholder benefit based on this rank. For example, it is possible to make the content of shareholder benefit more luxury according to the increase of the rank, or to make the content of shareholder benefits simpler according to the decrease of the rank.

The server 10 transmits the given shareholder benefit to the shareholder terminal 100 associated with the shareholder ID (step S04).

The shareholder terminal 100 receives the shareholder benefit and displays the content of the received shareholder benefit (step S05). For example, in a case of the login right to the dedicated service, a login status screen, a login availability date and the like are displayed. In a case of the installation right of the dedicated application, a link URL of a download destination of the dedicated application is displayed and the content for prompting the shareholder to install the dedicated application is displayed. In a case of the service right, a list of products or services that can be provided is displayed.

This is the overview of the shareholder benefit system 1.

System Configuration of Shareholder Benefit System 1

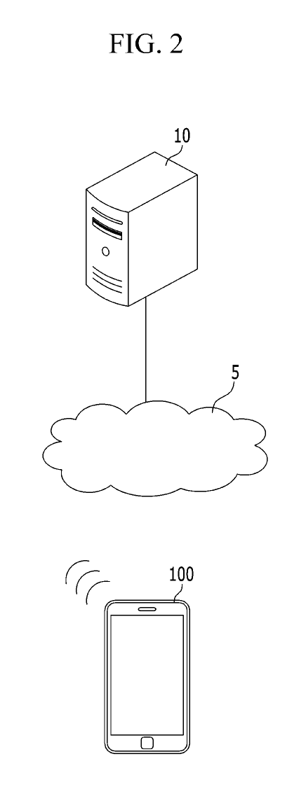

A system configuration of a shareholder benefit system 1 which is a preferred embodiment of the present invention is described with reference to FIG. 2. FIG. 2 is a diagram showing a system configuration of a shareholder benefit system 1 which is a preferred embodiment of the present invention. The shareholder benefit system 1 includes a server 10, a shareholder terminal 100, and a public line network (Internet network, third or fourth generation communication network, or the like) 5. Besides, the number of shareholder terminal(s) 100 is not limited to one, and may be two or more. Further, the server 10 and the shareholder terminal 100 are not limited to existing devices, and may be virtual devices. Furthermore, each process to be described below may be realized by either of the server 10 or the shareholder terminal 100, or both of them.

The server 10 is the above-described server device having functions to be described below.

The shareholder terminal 100 is the above-described terminal device having functions to be described below.

Description of Each Function

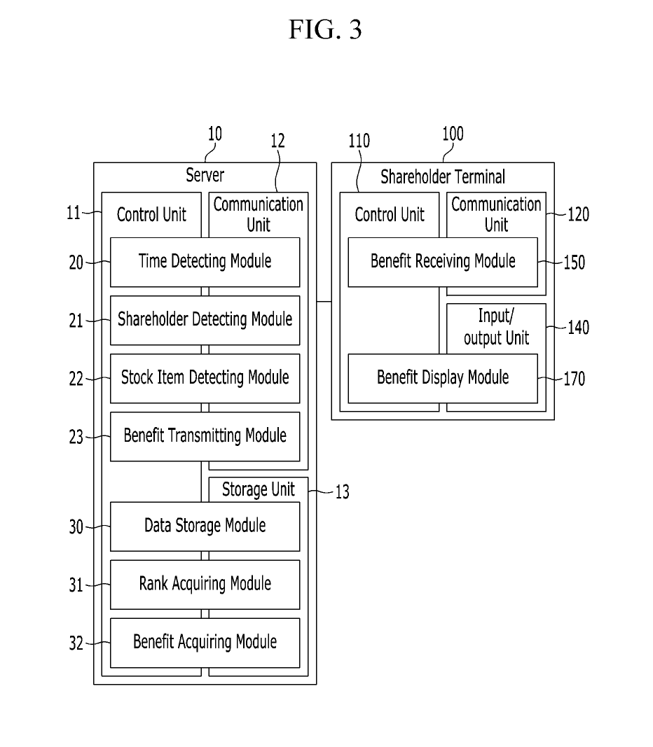

Functions of a shareholder benefit system 1 which is a preferred embodiment of the present invention is described with reference to FIG. 3. FIG. 3 is a functional block diagram of a server 10 and a shareholder terminal 100.

The server 10 includes, as a control unit 11, a CPU (Central Processing Unit), a RAM (Random Access Memory), a ROM (Read Only Memory), and the like, and includes, as a communication unit 12, a device for enabling communication with other devices, for example, WiFi (Wireless Fidelity) compliant device conforming to IEEE 802.11. In addition, the server 10 includes, as a storage unit 13, a data storage unit, such as a hard disk, a semiconductor memory, a recording medium, a memory card, or the like. In the storage unit 13, various databases to be described below are stored.

In the server 10, the control unit 11 reads a predetermined program, thereby realizing a time detecting module 20, a shareholder detecting module 21, a stock item detecting module 22, and a benefit transmitting module 23 in cooperation with the communication unit 12. In addition, in the server 10, the control unit 11 reads a predetermined program, thereby realizing a data storage module 30, a rank acquiring module 31, and a benefit acquiring module 32 in cooperation with the storage unit 13.

Like the server 10, the shareholder terminal 100 includes, as a control unit 110, a CPU, a RAM, a ROM, and the like, and includes, as a communication unit 120, a WiFi-compliant device or the like for enabling communication with other devices. In addition, the shareholder terminal 100 includes, as an input/output unit 140, a display unit for outputting and displaying data and images controlled by the control unit 110, an input unit such as a touch panel, a keyboard, or a mouse, for accepting an input from a shareholder.

In the shareholder terminal 100, the control unit 110 reads a predetermined program, thereby realizing a benefit receiving module 150 in cooperation with the communication unit 120. In addition, in the shareholder terminal 100, the control unit 110 reads a predetermined program, thereby realizing a benefit display module 170 in cooperation with the input/output unit 140.

Shareholder Benefit Process

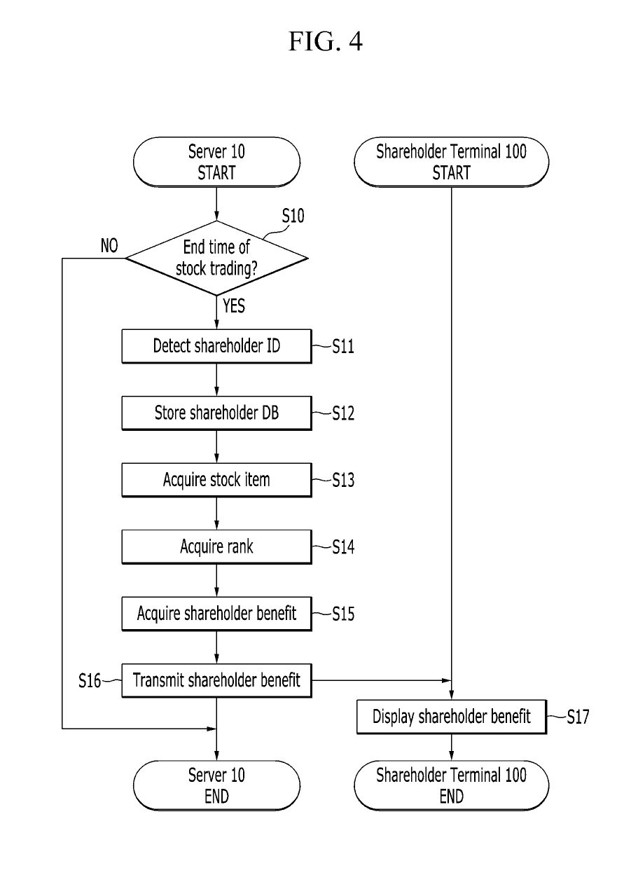

A shareholder benefit process executed by a shareholder benefit system 1 is described with reference to FIG. 4. FIG. 4 is a diagram showing a flowchart of a shareholder benefit process executed by a server 10 and a shareholder terminal 100. The processing executed by the above-described modules of each device is described together with this processing.

A time detecting module 20 determines whether a current time is an end time of stock trading (step S10). In step S10, the end time of the stock trading is an end time of a morning session or afternoon session, an end time of all morning and afternoon sessions, an end time of transaction of securities, or the like. In step S10, when determining that the stock trading is not over (NO in step S10), the time detecting module 20 ends this process. Further, this process is not limited to determining whether it is the end time of the stock trading in Japan, and may be configured to determine whether it is the end time of the stock trading in a foreign country. In this case, an administrator of the system, the shareholder or the like can appropriately change.

Further, the present process may be executed by a configuration other than the end time of stock trading. For example, the time detecting module 20 may be configured to determine whether a predetermined time has elapsed from the timing when the present process has been performed last time. For example, 1 hour, 2 hours, 12 hours, 24 hours, and the like are examples of the elapse of the predetermined time. Further, instead of the elapse of the predetermined time, a process to be described below may be executed at predetermined time intervals from the timing when the present process has been performed last time. The predetermined time interval is, for example, 1 hour interval, 2 hour interval, 12 hour interval, 24 hour interval, or the like. The configuration of the predetermined time interval can be appropriately changed.

On the other hand, in step S10, when the time detecting module 20 determines that the stock trading is over (YES in step S10), a shareholder detecting module 21 detects a shareholder ID associated with a shareholder holding a stock (step S11). In step S11, the shareholder detecting module 21 detects a plurality of shareholder IDs associated with one stock by referring to a stock item database. The shareholder ID is an ID for identifying the shareholder, which is assigned to one shareholder. The shareholder ID is assigned to each shareholder, for example, when the shareholder opens an account. One shareholder is associated with one shareholder ID. The shareholder ID may be assigned to the shareholder using the shareholder benefit system 1 or may be assigned by other configurations. In addition, the shareholder detecting module 21 may be configured to detect the shareholder ID from a stock company, a stock exchange, an external server, a database, or the like. Further, the identifier for identifying the shareholder is not limited to the ID, and may be an IP address, a MAC address, or other configuration. Furthermore, the shareholder detecting module 21 may be configured to detect the shareholder ID from an external server such as a server of the stock company or a server of the stock exchange, a database, or the like, without being limited to the stock item database.

Stock Item Database

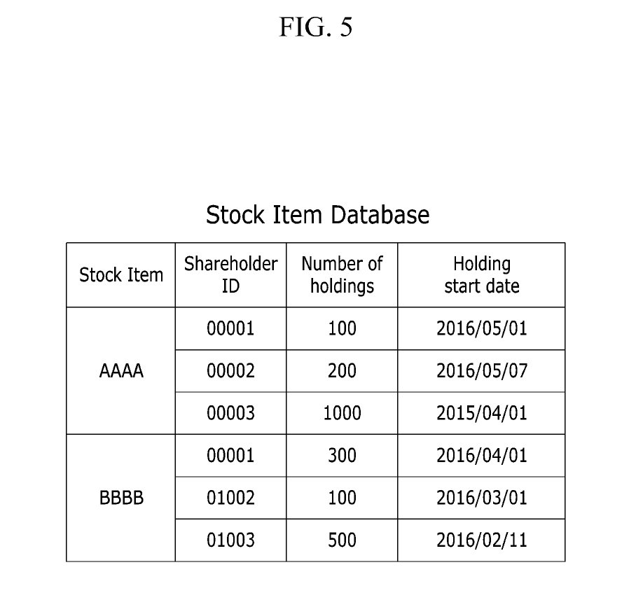

A stock item database stored by a data storage module 30 is described with reference to FIG. 5. FIG. 5 is a diagram showing a stock item database stored by a data storage module 30. In FIG. 5, the data storage module 30 stores a stock item, a shareholder ID, a number of holdings, and a holding start date in association with each other. The stock item is a name of a stock. The shareholder ID is an identifier for identifying a shareholder. The number of holdings is the number of shares of a stock with the stock item, which are held by the shareholder associated with the shareholder ID. The holding start date is the date on which the shareholder associated with the shareholder ID has started holding this stock. In FIG. 5, the data storage module 30 stores a plurality of shareholder IDs in association with one stock item. In FIG. 5, the data storage module 30 stores the number of holdings and the holding start date in association with each shareholder ID. That is, the stock item database is a database of shareholders holding one stock item.

While a plurality of stock items are shown in the present embodiment, only one stock item may be stored. In this case, a stock item database may be configured to exist for each stock item. Further, each item of the stock item database can be appropriately changed. For example, a configuration of storing the number of holding days instead of the holding start date or a configuration of adding the number of holding days may be employed. Furthermore, the stock item is not limited to the name of the stock, but may have any configuration as long as it is possible to uniquely identify a stock item such as a stock code.

The server 10 acquires the shareholder ID, the number of holdings, and the holding start date of the shareholder holding each stock from a stock company, another server, a database or the like, creates and stores the stock item database. In the stock item database, an item other than the above-described items may be added. Further, the number of stock items and the number of shareholder IDs to be stored as the stock item database can be appropriately changed.

The data storage module 30 creates and stores a shareholder database based on stocks associated with the detected shareholder ID (step S12). In step S12, the data storage module 30 stores the detected one shareholder ID in association with a plurality of stock items associated with the one shareholder ID.

Shareholder Database

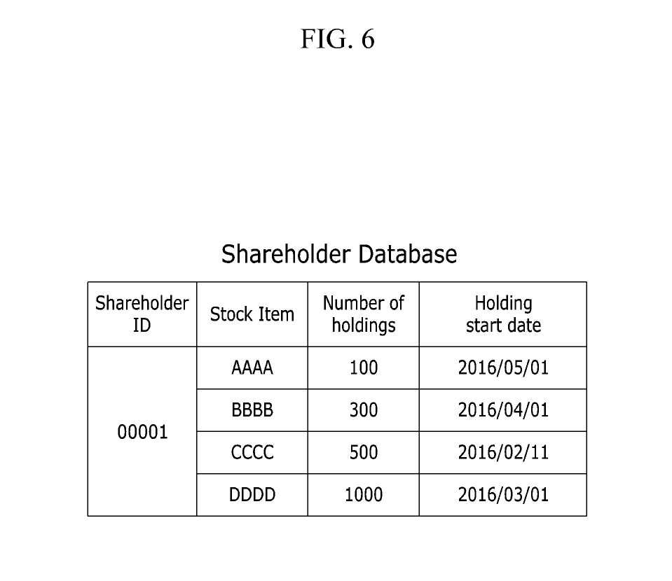

A shareholder database stored by a data storage module 30 is described with reference to FIG. 6. FIG. 6 is a diagram showing a shareholder database stored by a data storage module 30. In FIG. 6, the data storage module 30 stores a plurality of stock items, the number of holdings, and a holding start date in association with one shareholder ID. The shareholder ID, the stock item, the number of holdings, and the holding start date are the same as those of the stock item database described above. That is, the shareholder database is a database of stock items held by one shareholder.

While only one shareholder ID is shown in the present embodiment, a plurality of shareholder IDs may be stored. Further, the shareholder database may be configured to exist for each shareholder ID. Furthermore, each item can be appropriately changed like the above-described stock database.

A stock item detecting module 22 acquires a stock item held by the shareholder associated with the detected shareholder ID (step S13). In step S13, the stock item held by the shareholder is determined by referring to the shareholder database and acquiring all the stock items associated with the acquired one shareholder ID. At this time, the number of holdings and the holding start date of this stock item may be also acquired. In step S12, the stock item detecting module 22 may be configured to detect stock items of stocks held by the shareholder associated with the shareholder ID from a stock company, a stock exchange, an external server, a database, or the like. Further, the processing of step S12 and step S13 may be omitted. In this case, any configuration may be employed as long as the processing of step S11 is executed and each processing to be described below is executed based on the detected stockholder ID, stock item, number of holdings, holding start date, and the like.

A rank acquiring module 31 acquires a rank in each stock held by the shareholder associated with the detected shareholder ID (step S14). In step S14, the rank acquiring module 31 acquires the rank associated with the detected shareholder ID by referring to a rank database.

Rank Database

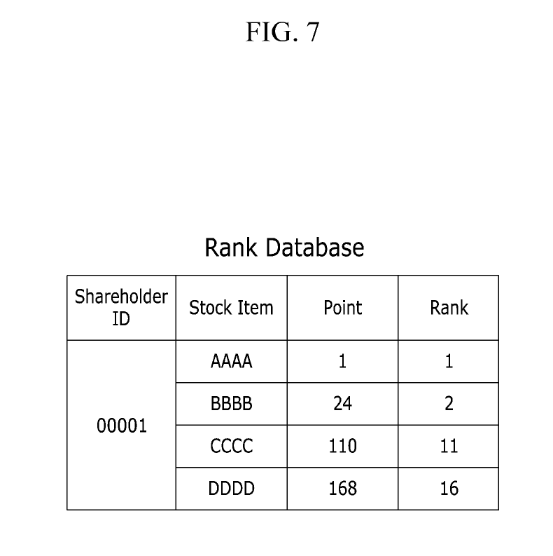

A rank database stored by a data storage module 30 is described with reference to FIG. 7. FIG. 7 is a diagram showing a rank database stored by a data storage module 30. In FIG. 7, the data storage module 30 stores a plurality of stock items, points and ranks in association with one shareholder ID. The shareholder ID and the stock item are the same as those described above. The point is calculated based on the number of holdings in the stock item held by the shareholder and the number of holding days indicating from the holding start date to the date at the current time. In detail, the data storage module 30 stores the number of holdings and the number of holding days/365 days (it may be 366 days in a case of a leap year). For example, when the number of holdings is 100 and the number of holding days is 1/(365 days), the data storage module 30 calculates the point as 1 (rounding down decimal places). Similarly, the data storage module 30 calculates points for all the stock items held by the shareholder. The data storage module 30 determines the ranking based on the point calculated in this manner. The rank is a value determined for a predetermined point. For example, when the point is from 1 to 10, the rank is determined as 1. Likewise, the data storage module 30 determines the rank of the shareholder holding this stock item. That is, the point increases as the number of holdings increases and the number of holding days increases.

The point decreases when the shareholder sells the stock, and increases when the shareholder purchase the stock. The rank decreases when the point decreases, and increases when the point increases. That is, the rank changes according to the point. The data storage module 30 changes and manages the rank of the shareholder when this point satisfies a predetermined condition, for example, a condition of the number of holdings, the number of holding days, or the like.

The method of calculating the point is not limited to the above-described configuration, and other configurations may be employed. For example, it may be calculated by multiplying the number of holdings and the number of holding days, or rounding off decimal places or rounding down decimal places. Further, the method of determining the rank is not limited to the above-described configuration, and other configurations may be employed. For example, a width of the point may be set to be larger, the width of the point may be set to be smaller, or the same number as the point may be used.

Further, the point and the rank are not necessarily indispensable, and a configuration in which the processing to be described below is executed based on the number of holdings may be employed. In this case, the above-described rank database may be omitted, the rank in each processing to be described below may be replaced into the number of holdings, and other configurations may be used.

A benefit acquiring module 32 acquires a shareholder benefit associated with each stock item (step S15). In step S15, the benefit acquiring module 32 acquires the shareholder benefit based on a benefit database.

Benefit Database

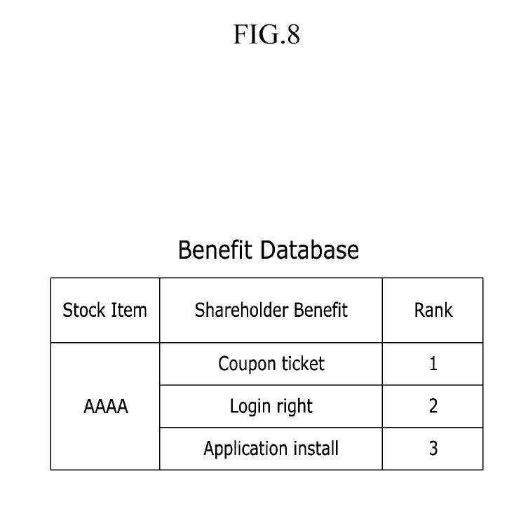

A benefit database stored by a data storage module 30 is described with reference to FIG. 8. FIG. 8 is a diagram showing a benefit database stored by a data storage module 30. In FIG. 8, the data storage module 30 stores one stock item, a plurality of shareholder benefits, and ranks in association with each other. The one stock item and ranks are the same as those described above. The shareholder benefit is, for example, a login right to a dedicated service, an installation right of a dedicated application, a service right which can receive a product or service of a company issuing the stock, such as a coupon ticket or a gift certificate. The benefit acquiring module 32 compares the rank of the current shareholder ID in the rank database with the ranks in the benefit database and acquires all shareholder benefits which are lower than or equal to the rank of the shareholder ID. For example, when the rank of the shareholder ID is 3, the benefit acquiring module 32 acquires the coupon ticket, the login right, and the application installation as the shareholder benefits.

Further, the benefit acquiring module 32 may not be configured to acquire all the shareholder benefits which are lower than or equal to the rank of the shareholder ID. For example, the benefit acquiring module 32 may be configured to acquire only the shareholder benefit that matches the rank of the shareholder ID, or may employ other configurations. Furthermore, the data storage module 30 may be configured to store a plurality of shareholder benefits in association with one rank. For example, the coupon ticket and the login right may be associated with the rank of 2. In this case, the benefit acquiring module 32 may acquire the shareholder benefit associated with the rank which matches the rank of shareholder ID.

A benefit transmitting module 23 transmits the acquired shareholder benefit to the shareholder terminal 100 associated with the shareholder ID (step S16).

A benefit receiving module 150 receives the shareholder benefit transmitted by the server 10. A benefit display module 170 displays the content of the shareholder benefit based on the received shareholder benefit (step S17). The content of the shareholder benefit displayed by the benefit display module 170, for example, displays a dedicated service, a login availability date, a shareholder ID, and the like in a case of a login right to the dedicated service, displays a download destination URL of a dedicated application and a download method in a case of installation of the dedicated application, and displays a coupon ticket, usable dates, a list of products or services, usable shops, URLs of usable selling sites, and the like in a case of the coupon ticket.

This is the shareholder benefit process.

While the process of executing the shareholder benefit on a daily basis has been described in the above-described embodiment, the process may be executed on a timely basis rather than the daily basis. In this case, the processing related to the number of days in the process described above may be configured to replace the number of days into time. Further, the server 10 may be configured to execute each processing for the point or rank based on the holding time or the like instead of the number of holding days.

According to the above-described shareholder benefit process, it is possible to grasp shareholders in real time and to give the shareholder benefits to the shareholders holding the stock in real time. Further, it is possible to grant the login right to dedicated service in real time. Furthermore, it is possible to varying and managing the ranks by giving points to the shareholders. For example, even if one stock item is held in the morning, the benefit of that day that could not be served if the stock is sold at the end of the stock trading can become to be served.

That is, if the stock is held, it is possible to receive the shareholder benefit of that day so that each day is a benefit day. Therefore, there is no constraint that it is necessary to hold the stock on 31st March, which is the settlement date.

The means and functions described above are realized by reading and executing a predetermined program by a computer (including a CPU, an information processing device, or various terminals). The program is provided, for example, in a form recorded in a computer-readable recording medium such as a flexible disk, a CD (e.g., CD-ROM or the like), a DVD (DVD-ROM, DVD-RAM, or the like), or the like. In this case, the computer reads the program from the recording medium and transfers the program to an internal storage unit or an external storage unit so as to be stored and executed. Furthermore, the program may be, for example, recorded in a storage device (recording medium) such as a magnetic disk, an optical disk, an optical magnetic disk, or the like in advance and be provided from the recording medium to the computer via communication line.

While the embodiments of the present invention have been described above, the present invention is not limited to the above-described embodiments. In addition, the effects described in the embodiments of the present invention are merely a list of the most preferable effects produced by the present invention, and the effects of the present invention are limited to those described in the embodiments of the present invention.

### DESCRIPTION OF REFERENCE NUMBERS

1: shareholder benefit system, 10: server, 100: shareholder terminal

What is claimed is:

1. A shareholder benefit system for giving a benefit to a shareholder on a daily basis, the shareholder benefit system comprising:
a shareholder detecting unit that detects a shareholder ID holding a stock at an end of stock trading;
a stock item determining unit that determines a stock item held by the detected shareholder ID; and
a shareholder benefit unit that gives a benefit to the shareholder ID on a daily basis based on the determined stock item.

2. The shareholder benefit system according to claim 1, wherein the shareholder benefit unit that gives a login right to a dedicated service associated with the shareholder ID on the daily basis based on the determined stock item.

3. The shareholder benefit system according to claim 1, wherein the shareholder benefit unit that associates a point with the shareholder ID on the daily basis based on the determined stock item.

4. The shareholder benefit system according to claim 3, further comprising a rank changing and managing unit that changes and manages a rank of a shareholder associated with the shareholder ID when the associated point satisfies a predetermined condition.

5. A shareholder benefit system for giving a benefit to a shareholder on a timely basis, the shareholder benefit system comprising:
a shareholder detecting unit that detects a shareholder ID holding a stock at predetermined time intervals;
a stock item determining unit that determines a stock item held by the detected shareholder ID; and
a shareholder benefit unit that gives a benefit to the shareholder ID on a timely basis based on the determined stock item.

6. The shareholder benefit system according to claim 5, wherein the shareholder benefit unit that gives a login right to a dedicated service associated with the shareholder ID on the timely basis based on the determined stock item.

7. The shareholder benefit system according to claim 5, wherein the shareholder benefit unit that associates a point with the shareholder ID on the timely basis based on the determined stock item.

8. The shareholder benefit system according to claim 7, further comprising a rank changing and managing unit that changes and manages a rank of a shareholder associated with the shareholder ID when the associated point satisfies a predetermined condition.

9. A shareholder benefit method for giving a benefit to a shareholder on a daily basis, the shareholder benefit method comprising:
detecting a shareholder ID holding a stock at an end of stock trading;
determining a stock item held by the detected shareholder ID; and
giving a benefit to the shareholder ID on a daily basis based on the determined stock item.

10. A shareholder benefit method for giving a benefit to a shareholder on a timely basis, the shareholder benefit method comprising:
detecting a shareholder ID holding a stock at predetermined time intervals;
determining a stock item held by the detected shareholder ID; and
giving a benefit to the shareholder ID on a timely basis based on the determined stock item.

11. A program for causing a shareholder benefit system for giving a benefit to a shareholder on a daily basis to execute:
detecting a shareholder ID holding a stock at an end of stock trading;
determining a stock item held by the detected shareholder ID; and
giving a benefit to the shareholder ID on a daily basis based on the determined stock item.

12. A program for causing a shareholder benefit system for giving a benefit to a shareholder on a timely basis to execute:
detecting a shareholder ID holding a stock at predetermined time intervals;
determining a stock item held by the detected shareholder ID; and
giving a benefit to the shareholder ID on a timely basis based on the determined stock item.
